(19) United States
(12) Patent Application Publication
(10) Pub. No.: US 2009/0265234 A1
(43) Pub. Date: Oct. 22, 2009

(54) Method for processing digital rebates and coupons

(76) Inventor: Neil I. Harris, Burnsville, NC (US)

Correspondence Address: DAVID M. CARTER;CARTER & SCHNEDLER, P.A., P.O. BOX 2985, ASHEVILLE, NC, 28802, US

(21) Appl. No.: 12/386,275

(22) Filed: Apr. 15, 2009

Related U.S. Application Data
(60) Provisional application No. 61/124,835, filed on Apr. 17, 2008.

(51) Int. Cl. G06Q 30/00; G06Q 20/00

(52) U.S. Cl. 705/14; 705/26; 705/40

(57) ABSTRACT

There is provided a method for processing retail price discounts or rebates in connection with the purchase of merchandise. A data center is provided for processing discounts or rebates. The data center has at least one (1) computer to perform at least a portion of the processing. Consumers are notified of the availability of a discount or rebate for the merchandise. Consumers query the data center regarding the availability of the discount or rebate. The data center obtains an authorization from the consumer to debit or charge an account for the purchase of the merchandise. The data center issues a digital certificate from the computer reflecting the discount or rebate. The consumer's account is charged or debited or the consumer pays for the price of the merchandise less the discount upon presentation of the digital certificate to the retailer for the purchase of the merchandise.

### RELATIONSHIP TO PRIOR APPLICATIONS

This is a U.S. non-provisional application relating to and claiming the benefit of U.S. Provisional Patent Application Ser. No. 61/124,835, filed Apr. 17, 2008.

### BACKGROUND

Manufacturers and retailers currently issue coupons in paper form. Consumers are required to clip these coupons from a newspaper or magazine and physically take those paper coupons to a store where the item is purchased in order to obtain a discount. The retailer often must mail the coupons to the manufacturer. In order to obtain a rebate on an item purchased, the consumer often must cut a piece of the merchandise containing box showing a UPC code or other information and mail that item, together with a copy of the sales receipt, to the manufacturer within a certain time frame. Obviously, this paper coupon/rebate process is very awkward and time consuming in today's digital world.

### SUMMARY

In accordance with one form of this invention there is provided a method for processing retail price discounts or rebates in connection with the purchase of merchandise. A data center is provided for processing discounts or rebates. The data center has at least one (1) computer to perform at least a portion of the processing. Consumers are notified of the availability of a discount or rebate for the merchandise. Consumers query the data center regarding the availability of the discount or rebate. The data center obtains an authorization from the consumer to debit or charge an account for the purchase of the merchandise. The data center issues a digital certificate from the computer reflecting the discount or rebate. The consumer's account is charged or debited or the consumer pays for the price of the merchandise less the discount upon presentation of the digital certificate to the retailer for the purchase of the merchandise. Preferably, communications are established between the digital certificate and the data center prior to the charging or debiting of the consumer's account. Also preferably, a portion of the purchase price of the merchandise is retained by the data center as a processing fee.

### BRIEF DESCRIPTION OF THE DRAWINGS

FIG. 1 is a schematic diagram illustrating certain features of Applicant's invention.

FIG. 2 is another schematic diagram illustrating certain features of Applicant's invention.

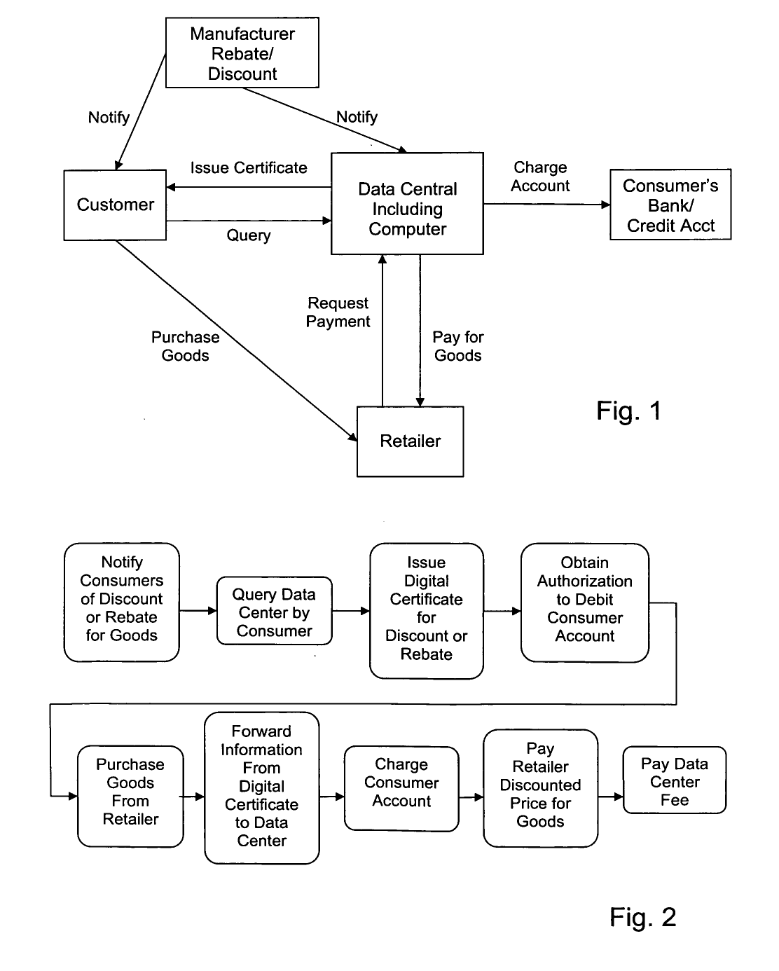

### DESCRIPTION OF THE PREFERRED EMBODIMENT

The invention includes the creation of a digital rebate and coupon bank (“DRCB”). The DRCB includes a data center having a call facility and a data processing facility having at least one computer. One method for processing digital rebates and discount coupons is set forth below. As used herein, the term “Price Reduction” includes a discounts, such as shown on coupons, and rebates.

For coupons, a consumer first sees an advertisement for some merchandise which states that a seller's discount coupon is available only if you call a certain telephone number, which is the DRCB telephone number, or access the data processing facility through the internet. Often, the discount is advertised by the manufacturer or retailer. The consumer calls or accesses DRCB and gives DRCB certain customer information, such as name and address and a credit or debit card number and gives DRCB authorization to charge the account associated with the debit or credit card. The DRCB issues a digital certificate or processing card to the consumer. The digital certificate contains information to show that the consumer is entitled to a discount for that merchandise. The digital certificate or processing card, which contains a bar code, is e-mailed to the consumer. Preferably, a more permanent plastic card containing the same information as the digital certificate is mailed to the consumer by postal mail.

In order to obtain the discount for the merchandise, i.e., to use the digital certificate, the consumer must go to the retailer within a predetermined time period, such as within three (3) days. The retailer scans the digital certificate which communicates with the DRCB to debit the consumer's credit or debit card to pay for the merchandise, less the value of the discount. A portion of the seller's proceeds is retained by DRCB as a processing fee. Alternatively, the consumer may pay for the merchandise by cash or by check.

When the consumer first contacts the DRCB to obtain the digital certificate, information is sent to the retailer to hold the coupon and the merchandise for a predetermined number of days for that consumer. If the consumer does not arrive at the retailer within that predetermined time period, then the transaction is voided and the merchandise and discount coupon are no longer held for that consumer.

An “instant” rebate process works similarly to the discount coupon process except that the advertisement will inform the consumer that there is a rebate available for the merchandise and the consumer must call DRCB or contact DRCB over the internet to obtain a digital certificate or processing card that shows that the consumer is entitled to the rebate. The consumer must arrive at the retailer's place of business within a predetermined number of days, buy the merchandise and have their credit or debit card debited at the final transaction. DRCB retains a small portion of the seller's proceeds as a processing fee.

The proceeds of the transaction less the coupon discount and/or rebate and processing fee is forwarded to the retailer. Thus, an entirely paperless discount coupon and rebate program is provided. In addition, the bulk of the sales transaction is handled by the DRBC.

Additional features of the invention are set forth below.

The DRCB is designed to become the expediter and facilitator of electronic transactions involving discounts and rebates, closing the loop between manufacturer/retailer's offers and the final sale.

Compelling discounts and rebates placed before consumers on television, radio, cinema, the internet and print, etc., drive business to local retailers. Customers can elect to “lock-in their deals” (reserve their discount coupon or rebate) by utilizing a 1-800 telephone number or website and request a digital certificate in the form of a processing card that is used to apply their reserved discount coupon or rebate to their transaction.

DRBC will reconcile the manufacturer's electronic coupons and rebates at the point-of-sale, process the consumers credit or debit card which is authorized by the processing card that has been issued to each customer and charge a fee for its financial processing services.

Manufacturers and marketers, advertising agencies, TV station groups, publishers, cable channels, radio stations, out of home entities, internet companies, cinema promotions, branded opportunities and entertainment companies are also potential parties involved in these types of transactions.

It is anticipated that DRCB will employ sales teams to prepare their presentation, pricing and marketing program to potential clients. DRCB may be included into promotions and advertising, so business can be funneled into businesses and retail partners.

Numeric coding for digital coupons and rebates, manufacturer rebate or coupon bundles are created and stored in DRCB's computer repository and are secured for storage and electronic transfer of digital certificates preferably using encryption technologies.

The manufacturer's and retailer's digital discount coupons are then ready to be reserved by consumers and utilized at the retail point-of-sale.

An ad is created and a ‘Value Added Deal’ is presented to the client for approval and the approved ad is scheduled for consumer presentation.

A final ad with the offering with the discount or rebate is delivered for media output and distribution.

Upon viewing or hearing about a compelling offering by a manufacturer or marketer, the customer may request a hold be placed on a discount coupon or rebate by DRCB until that discount or rebate can be digitally applied to their transaction at the point-of-sale.

There may be a finite number of digital certificates available and a limited amount of time to take advantage of the offering. The digital coupon or rebate remains at DRCB for a predetermined time and until it is redeemed electronically at the manufacturer's local franchisee, dealer, or retailer checkout counter.

A DRCB cardholder uses his/her card to allow purchases where discount coupons and/or rebates can be applied to their purchase at participating retailers. The customer may also load instant case rebates into their on-file card or choose to apply the rebate to the transaction. The DRCB card (swipe first) acknowledges that the cardholder has a discount coupon or rebate on hold that will be applied to the transaction on either the DRCB card or the customer's on-file payment card (swipe second) such as a credit or debit card. It also tracks the location of the transaction and the amount actually paid for the item.

The DRCB card, similar to a bank debit card, holds the access code that connects a Point-of-Sale (“POS”) to DRCB's data base in its computer, enables reconciling the coupon or rebate unique to that cardholder's account and is further secured by a personal identification (PIN) which can be assigned by DRCB or chosen by the member to give access to their account for applying their coupon or rebate to the transaction. Cardholders are offered the opportunity to change the PIN at any time.

Every POS system has the capability to read the magnetic stripe on back of the card, authorize reconciling the coupon or rebate information to the transaction and completing payment once the cardholder's PIN is recognized and a four digit approval code is inserted by the retail store's manager or cashier.

The DRCB system can load many coupons or rebates, based on customer preferences, into their personal DRCB database in the DRCB computer, which can be applied to multiple opportunities throughout their local community or on the DRCB website. The personal DRCB cardholder account reflects the time limits of the manufacturers' offers and the capability to send e-mail or text notices warning expiration times and dates.

DRCB enables the customer to “lock in my deal” by calling a 1-800 number or e-mailing DRCB or accessing DRCB's website. By contacting DRCB regarding a specific promotion, customers can lock in their deal, request a text receipt be delivered to their cell phone, computer or fax machine and secure a DRCB digital certificate or processing card.

The DRCB processing card enables the customer to utilize the rebate or coupon at the point-of-sale and complete the transaction. Initially, a temporary DRCB card or digital certificate is sent to the customer's e-mail, where it can be printed out for immediate use. This is followed by a permanent card, which is mailed to the customer's home or business and which can also be used to take advantage of future promotions.

DRCB sends an alert to the manufacturer that a customer has requested a hold on a specific discount coupon and monitors the performance of the promotion. The manufacturer notifies the retail partner, nearest the zip code address of the customer, to prepare for a sale.

DRCB acts as a facilitator which stores the manufacturer's digital certificates in its repository, performs the closing transaction by picking up the “locked-in” deal reserved by the customer, reconciles the reserved digital rebate or discount coupon at the point-of-sale and charges the customer's credit card and charges a processing fee.

DRCB also reports the performance of the promotion to its clients.

From the foregoing description of the preferred embodiment of the invention, it will be apparent that many modifications may be made therein. It should be understood, however, that this embodiment of the invention is an exemplification of the invention only and that the invention is not limited thereto. It is to be understood, therefore, that it is intended in the appended claims to cover all modifications as fall within the true spirit and scope of the invention.

What is claimed is:

1. A method for processing retail price reductions in connection with the purchase of merchandise comprising:
providing a data center for processing price reductions; the data center including at least one computer;
notifying consumers of the availability of a price reduction for the merchandise; the price reduction being in the form of a discount or a rebate;
receiving queries from a consumer regarding the price reduction;
obtaining authorization from the consumer to debit or charge an account for the purchase of the merchandise;
issuing to the consumer a digital certificate from the computer reflecting the price reduction; and
charging, debiting or receiving payment from the consumer for the merchandise less the price reduction upon presentation of the digital certificate to the retailer for the purchase of the merchandise.

2. A method as set forth in claim 1 further including establishing communications between the digital certificate and the data center prior to charging the consumer's account.

3. A method as set forth in claim 1 wherein the digital certificate includes a bar code at least reflecting the amount of the price reduction.

4. A method as set forth in claim 1 further including receiving consumer information by the data center.

5. A method as set forth in claim 4 wherein the consumer information includes an account number for an account which is available to be charged for the purchase of the merchandise.

6. A method as set forth in claim 1 further including setting a predetermined time period for the consumer to present the digital certificate to the retailer in order for the consumer to obtain the price reduction for the merchandise.

7. A method as set forth in claim 6 further including informing the retailer to hold the merchandise for the consumer for the predetermined time period.

8. A method as set forth in claim 7 further including voiding the transaction after the passage of the predetermined time period.

9. A method as set forth in claim 1 further including the data center retaining a portion of the purchase price of the merchandise as a processing fee.

10. A method as set forth in claim 1 further including forwarding a more permanent card to the consumer which contains information from the digital certificate.

11. A method as set forth in claim 1 further including e-mailing the digital certificate to the computer.

12. A method as set forth in claim 1 further including paying the retailer the price for the merchandise less the price reduction and less a fee retained by the data center.

13. A method as set forth in claim 1 wherein the queries are received by the computer through the internet.

14. A method as set forth in claim 1 wherein the queries are received via telephone; and further including storing information regarding the queries in the computer.

15. A method for processing retail price reductions in connection with the purchase of merchandise comprising:
notifying consumers through media of the availability of a price reduction for the merchandise;
receiving queries at a processing center from consumers regarding the price reduction; the processing center including at least one computer;
issuing a digital certificate to the consumer from the computer reflecting the price reduction; and
charging, debiting or receiving payment from the consumer for the price of the merchandise less the discount upon presentation of the digital certificate to a retailer for the purchase of the merchandise.

16. A method for processing retail price reductions in connection with the purchase of merchandise comprising:
providing a data center for processing price reductions; the data center including at least one computer;
notifying consumers of the availability of a price reduction for the merchandise; the price reduction being in the form of a discount or a rebate;
receiving queries by the data center from a consumer regarding the price reduction;
obtaining authorization from the consumer to debit or charge an account for the purchase of the merchandise;
issuing to the consumer a digital certificate from the computer reflecting the price reduction;
setting a predetermined time period for the consumer to present the digital certificate to the retailer in order for the consumer to obtain the price reduction;
informing the retailer to hold the merchandise for the consumer for the predetermined time period; and
charging, debiting or receiving payment from the consumer for the price of the merchandise less the price reduction and less a fee paid to the data center upon presentation of the digital certificate to the retailer for the purchase of the merchandise.
